(19) United States
(12) Patent Application Publication
(10) Pub. No.: US 2009/0256517 A1
(43) Pub. Date: Oct. 15, 2009

(54) WEIGHTED FIELD ORIENTED MOTOR CONTROL FOR A VEHICLE

(76) Inventors: Andrew David Baglino, San Francisco, CA (US); Troy Adam Nergaard, San Francisco, CA (US); Heath Hofmann, State College, PA (US)

Correspondence Address: SCHWEGMAN, LUNDBERG & WOESSNER, P.A., P.O. BOX 2938, MINNEAPOLIS, MN, 55402, US

(21) Appl. No.: 12/100,836

(22) Filed: Apr. 10, 2008

(51) Int. Cl. H02P 23/14

(52) U.S. Cl. 318/772; 318/799

(57) ABSTRACT

A system for transitioned field oriented motor control is described. The system may include a module using a current-based algorithm to estimate flux and a module using a voltage-based algorithm to estimate flux. A weighting module operates over a transition range to transition between the flux estimate using the current-based algorithm to the flux estimate using the voltage-based algorithm based on a weighted combination of the flux estimates. Other embodiments are described and claimed.

### BACKGROUND

An extremely large percentage of the world's vehicles run on gasoline using an internal combustion engine. The use of such vehicles, more specifically the use of vehicles which rely on fossil fuels, i.e., gasoline, creates two problems. First, due to the finite size and limited regional availability of such fuels, major price fluctuations and a generally upward pricing trend in the cost of gasoline are common, both of which can have a dramatic impact at the consumer level. Second, fossil fuel combustion is one of the primary sources of carbon dioxide, a greenhouse gas, and thus one of the leading contributors to global warming. Accordingly, considerable effort has been spent on finding alternative drive systems for use in both personal and commercial vehicles. Electric vehicles offer one of the most promising alternatives to vehicles that use internal combustion drive trains.

One of the principal issues involved in designing a comfortable and efficient electric drive for a vehicle lies in the control of the motor. Motor control has generally evolved from industrial, on-grid applications where power efficiency and constantly variable speed and torque commands are less prevalent.

### BRIEF DESCRIPTION OF THE DRAWINGS

Embodiments of inventive subject matter may be best understood by referring to the following description and accompanying drawings, which illustrate such embodiments. In the drawings:

FIG. 1 shows a vehicle system according to one embodiment of the present subject matter;

FIG. 2 is a block diagram of a system for motor control according to various embodiments;

FIG. 3 is a more detailed block diagram of a system for motor control according to various embodiments; and

FIG. 4 is a flow diagram illustrating a method for controlling a motor according to various embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

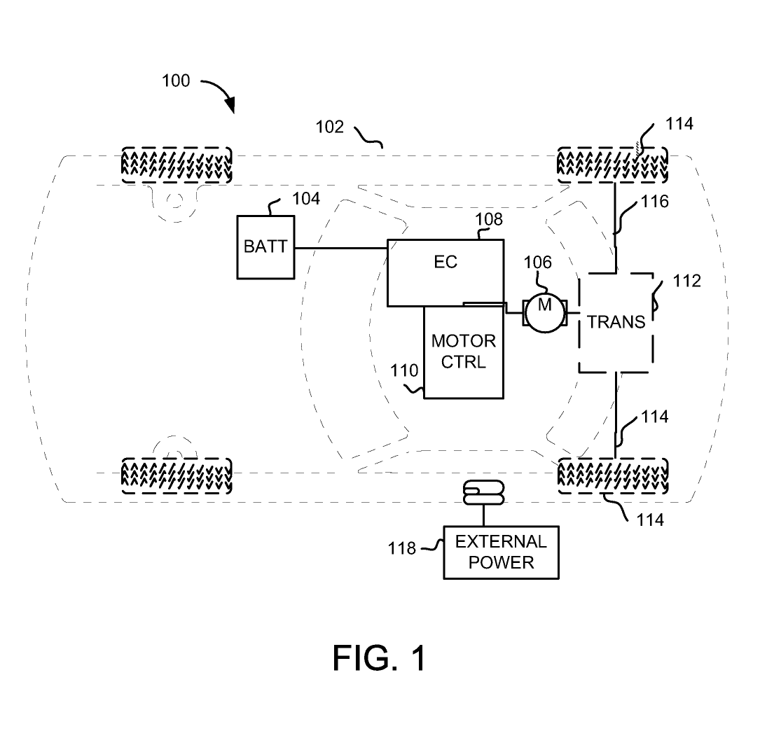

FIG. 1 shows an electric vehicle system 100 according to one embodiment of the present subject matter. In various embodiments, the vehicle 102 is an electric vehicle and includes a vehicle propulsion battery 104 and at least one propulsion motor 106 for converting battery energy into mechanical motion, such as rotary motion. The present subject matter includes examples in which the vehicle propulsion battery 104 is a subcomponent of an energy storage system (“ESS”). An ESS includes various components associated with transmitting energy to and from the vehicle propulsion battery in various examples, including safety components, cooling components, heating components, rectifiers, etc. The inventors have contemplated several examples of ESS, and the present subject matter should not be construed to be limited to the configurations disclosed herein, as other configurations of a vehicle propulsion battery and ancillary components are possible.

The vehicle propulsion battery 104 can include a lithium ion battery in various examples. In some examples, the vehicle propulsion battery 104 includes a plurality of lithium ion batteries coupled in parallel and/or series. Some examples include cylindrical lithium ion batteries. In some examples, the ESS includes one or more batteries compatible with the 18650 battery standard, but the present subject matter is not so limited. The vehicle propulsion battery 104, in some examples, provides approximately 390 volts.

Additionally illustrated is an energy converter 108. The energy converter 108 is part of a system which converts energy from the vehicle propulsion battery 104 into energy useable by the at least one propulsion motor 106. In some instances, the energy flow is from at least one propulsion motor 106 to the vehicle propulsion battery 104. As such, in some examples, the vehicle propulsion battery 104 transmits energy to the energy converter 108, which converts the energy into energy usable by the at least one propulsion motor 106 to propel the electric vehicle. In additional examples, at least one propulsion motor 106 generates energy that is transmitted to the energy converter 108. In these examples, the energy converter 108 converts the energy into energy which can be stored in the vehicle propulsion battery 104.

The energy converter 108 may include a motor controller 110 according to some embodiments. Additionally, the motor controller 110 may be a separate component from the energy converter 108. The motor controller 110 controls the operation of the propulsion motor 106. In some embodiments, the motor controller 110 may be considered a generator controller when it is controlling a generator or similar device. Commands for torque or speed for example may come from a driver or another source and can be translated by the motor controller 110 to derive output at the propulsion motor 106. One or more algorithms including estimates and measurements may be used by the motor controller 110 in order to provide appropriate commands to the propulsion motor 106 for output. Operating estimates and measurements may vary with time, motor speed, vehicle speed, battery voltage, system resistance, and other factors. Changes in these and other factors can influence the algorithms and equations used to derive commands for the propulsion motor 106 in the motor controller 110. According to various embodiments, at least two algorithms may be used by the motor controller 110 under various conditions. At different times, speeds, or during different driving conditions one algorithm may be used over the other. During a period between the varying driving conditions, a weighted combination of the algorithms may be used to produce commands for propulsion motor 106 output.

In some examples, the energy converter 108 includes transistors. Some examples include one or more field effect transistors. Some examples include metal oxide semiconductor field effect transistors. Some examples include one or more insulated gate bipolar transistors. As such, in various examples, the energy converter 108 includes a switch bank which is configured to receive a direct current (“DC”) power signal from the vehicle propulsion battery 104 and to output a three-phase alternating current (“AC”) signal to power the vehicle propulsion motor 106. In some examples, the energy converter 108 is configured to convert a three phase signal from the vehicle propulsion motor 106 to DC power to be stored in the vehicle propulsion battery 104. Some examples of the energy converter 108 convert energy from the vehicle propulsion battery 104 into energy usable by electrical loads other than the vehicle propulsion motor 106. Some of these examples switch energy from approximately 390 Volts to approximately 14 Volts.

The propulsion motor 106 is a three phase AC propulsion motor, in various examples. Some examples include a plurality of such motors. The present subject matter can optionally include a transmission 112 in some examples. While some examples include a 2-speed transmission, other examples are contemplated. Manually clutched transmissions are contemplated, as are those with hydraulic, electric, or electrohydraulic clutch actuation. Some examples employ a dual-clutch system that, during shifting, phases from one clutch coupled to a first gear to another clutch coupled to a second gear. Rotary motion is transmitted from the transmission 112 to wheels 114 via one or more axles 116, in various examples.

A charging station 118 may be provided to transmit energy with the vehicle propulsion battery 104, in various examples. In some examples, the charging station converts power from a 110V AC power source into power storable by the vehicle propulsion battery 104. In additional examples, the charging station converts power from a 220V AC power source into power storable by the vehicle propulsion battery 104. The present subject matter is not limited to examples in which a converter for converting energy from an external source to energy usable by the vehicle 102 is located outside the vehicle 102, and other examples are contemplated.

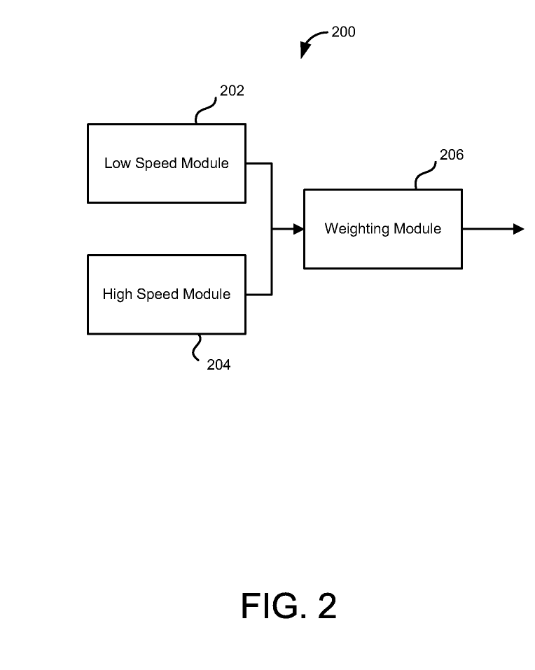

FIG. 2 is a block diagram of system 200 for motor control according to various embodiments. The system 200 includes a low speed module 202, a high speed module 204, and a weighting module 206.

An electric motor control system may include various modules for use in providing commands to a motor. The modules may be more or less applicable with varying operating conditions. The low speed module 202 includes algorithms and procedures to produce values used in determining motor commands generally at low motor speeds. The high speed module 204 includes algorithms and procedures to produce values used in determining motor commands generally at high motor speeds. Low and high motor speeds are relative terms, and merely describe the fact that in a particular situation under particular operating conditions, low motor speeds are slower than high motor speeds. According to various embodiments, the motor speed may be measured based on the rotations per minute (RPM) of a rotor in an AC induction motor. The determination of particular ranges which may be considered high speed or low speed depends on the particular algorithms and procedures used by the low speed module 202 and the high speed module 204. The ranges may generally be determined based on the performance characteristics of the low speed module and high speed module at a particular time or speed under particular operating conditions.

When a motor control system transitions between the low speed module 202 and the high speed module 204, a transition range can exist where both modules can be used to determine motor commands. In order to utilize the outputs of the low speed module 202 and the high speed module 204, the weighting module 206 may be used. The weighting module 206 can take the outputs of the low speed module 202 and the high speed module 204 and apply a weighting to each output in order to generate a weighted combination of the outputs of the two modules. The weighting may be adjusted through the transition range to move from utilizing substantially only the low speed module to utilizing substantially only the high speed module 204 to produce a variably weighted flux estimate according to various embodiments. The weighting may be linearly proportional to the progress through the transition range, or in accordance with other embodiments, the weighting may be determined based off another function.

The transition range during which the low speed module 202 and the high speed module 204 are weighted may be set as a static range, or may vary with operating conditions. Additionally, the transition range may represent a portion of the motor total operating range, or it may include substantially all of the motor's operating range, establishing a transition range through the entire operation of the motor. The transition range may be a measure of motor speed (RPM for example), time, torque output, or other motor characteristics.

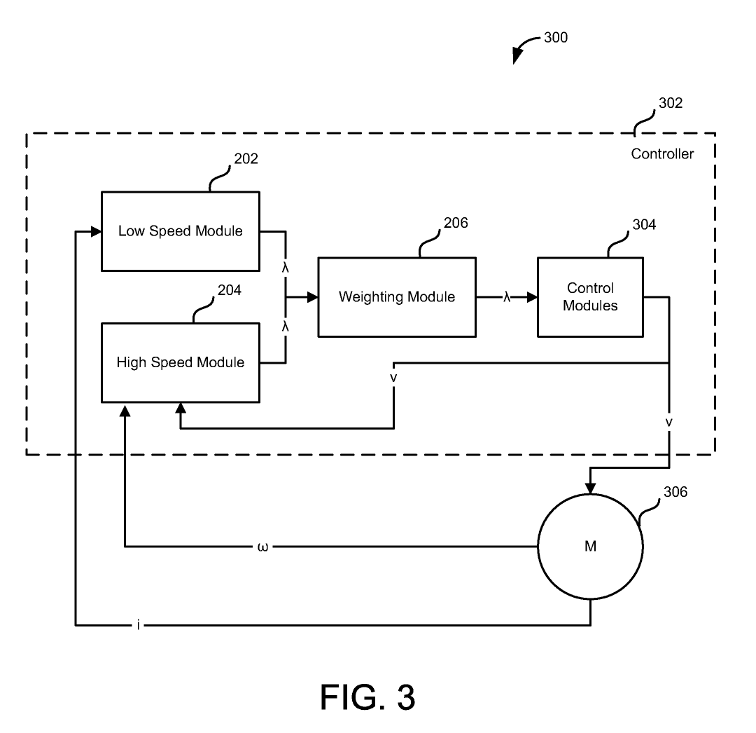

FIG. 3 is a more detailed block diagram of a system 300 for motor control according to various embodiments. The system 300 includes a controller 302, low speed module 202, high speed module 204, weighting module 206, control modules 304, and a motor 306.

The controller 302 includes the low speed module 202, the high speed module 204, the weighting module 206 and control modules 304. The controller 302 may include other modules to perform various functionalities according to some embodiments. The controller 302 may be generally referred to as a motor controller, but the controller 302 may also control the operation of other electric machines including but not limited to generators and motors. The operation of the motor 306 may be controlled by voltage commands from the controller 302, generally by way of the control modules 304. Current and speed measurements are taken from the motor 306 to be used by the low speed module 202 and the high speed module 204 in order to estimate the flux linkage (hereinafter “flux”) in the motor.

Generally a motor command voltage is based off of a torque command. A user of a motor—a driver of an electric vehicle, for example—will input a torque command to a drive system. As an example embodiment, the torque command may be derived at least in part from the position of the accelerator (colloquially “throttle” or “gas pedal”, although neither of those terms are technically applicable to electric motor operation). In order to accurately induce and determine the torque output of the motor 306, a motor flux value is needed. Rather than directly measuring the motor flux, a flux value can be estimated. The current-based low speed module 202 can estimate the motor flux using a current measurement and a measured motor speed taken off of the motor 306. The voltage-based high speed module 204 can estimate the motor flux based off of the phase voltage applied to the motor 306.

The high speed module 204 and the low speed module 202 have strengths and weaknesses at different motor speeds. Stability and accuracy are two characteristics which impact the use of the low speed module 202 and the high speed module 204 at varying motor speeds. The low speed module can be unstable at high speeds and more stable at low speeds. The high speed module can be inaccurate at low speeds and more accurate at high speeds. Transitioning from a flux estimate using the low speed module 202 to a flux estimate using the high speed 204 may enhance motor performance and controllability. According to various embodiments the transition point may occur at a threshold point based on where the inaccuracy of the high speed module is tolerable and the stability of the low speed module is not tolerable. The threshold point may be pre-defined, or may vary with changing driving and power supply conditions.

According to various embodiments, a transition range may be employed where flux estimates from both the low speed module and the high speed module are taken into account. The weighting module 206 may be utilized during the transition period (as described with reference to FIG. 2) to provide a weighted flux estimate using the outputs from the low speed module 202 and the high speed module 204. Over a transition range, the weighting module 206 may take the estimated flux values from the low speed module 202 and the high speed module 204 to produce a weighted flux estimate. The weighted flux estimate may take advantage of increasing accuracy in the high speed module 204 flux estimate and decreasing stability in the slow speed module 202 flux estimate as the speed of the motor 306 increases. The particular length and placement of the transition range may be based off of stability and accuracy thresholds which may be pre-defined, or may vary with changing driving and power supply conditions. According to one example embodiment, the transition range may begin at around 500 RPM and continue to around 1500 RPM. In other embodiments, the transition range may begin around 1000 RPM and continue to around 2000 RPM. The transition range may vary depending on the type and size of the motor, the weight and aerodynamics of the vehicle, the presence of other propulsion motors which may be providing torque, ambient temperature, motor temperature, battery temperature, battery voltage level, and other factors. These and other factors may be taken into account once in determining the transition range, or may constantly affect the transition range making it a continuously variable range during operation.

The weighting module 206 may output the weighted flux estimate to the control module 304. The control modules 304 may include a number of modules, algorithms and procedures within the controller 302 which are used to generate a voltage command for the motor 306. The control modules 304 may receive additional inputs which may include torque commands, voltage command adjustments, and other signals from various modules or sensors. Based on the inputs to the command modules 304, including the weighted flux estimate from the weighting module 206, a voltage command may be sent to the motor 306 to control its operation. In some embodiments, the voltage command may be the voltage that is to be applied across phase windings of the motor 306. In other embodiments the voltage command may be sent to an inverter which can convert the voltage command into AC voltage signals to be applied to the phase windings of the motor 306.

According to various embodiments, the flux estimates from the low speed module 202, the high speed module 204, or the weighting module 206 may be vector quantities, having an angle and a magnitude. According to various embodiments, weighting of quantities may be interpreted as a vector weighting of those quantities. A described weighting of flux estimates may be a vector weighting of those flux estimates. Additionally, the voltage command generated by the control modules 304 may be a vector quantity. The vector voltage command generated by the control modules 304 may be modulated and converted into an AC voltage signal before being sent to the motor 306.

According to an example embodiment, the low speed module 202 may estimate a flux value using measured phase currents and measured motor speed values. The estimation may be a rotor flux estimation and may be transformed into the stationary reference frame. Other examples of current-based flux estimate calculation are also considered. The motor speed measurements may be used in the low speed module 202 to help determine rotor flux based on rotor current electrical frequency, which is sensitive to the mechanical speed at which the rotor is spinning. The motor speed may be determined by a speed measurement module which may use a number of methods to measure speed. One example method may include using period measurement of quadrature motor encoder pulses for a range of motor speeds. Another speed measurement method, for another range of motor speeds where speed sensitivity is less prevalent, may include simply counting encoder edges seen by the controller 302 on a periodic bases (every 10 ms for example). These measurements may be sufficient to determine motor speed. Other speed measurement methods are considered for use by the speed measurement module.

The high speed module 204 may estimate a flux value with a stator flux estimate using a phase voltage approximation. The phase voltage approximation is based on a dead-time compensated phase voltage command minus a voltage drop for the stator winding in that particular phase. The stator winding voltage drop is equal to the current through the phase winding Iₛ multiplied by the resistance in the phase winding Rₛ. The determined phase voltage Vₛ may be used to calculate the flux in the stator by λ=∫Vₛ*dt. Other examples of voltage-based flux estimate calculation are also considered.

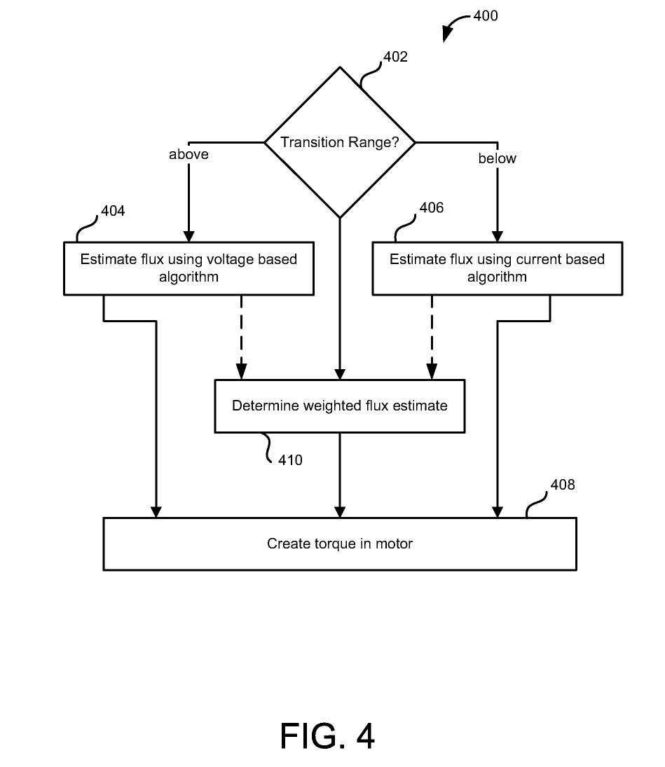

FIG. 4 is a flow diagram illustrating a method 400 for controlling a motor according to various embodiments. The method 400 begins by determining if the motor is operating within a transition range (block 402). The transition range may be defined by a particular rotational speed range of the motor, an actual speed range of a vehicle which is propelled by the motor, a time range, a torque output range or other characteristic ranges related to the motor. If the motor is not operating within the transition range, it may be operating above or below the transition range. If the motor is operating above the transition range a flux estimation module may be invoked which uses a voltage-based algorithm (block 404). If the motor is operating below the transition range a flux estimation module may be invoked which uses a current-based algorithm (block 406). The estimated flux from either flux estimation (blocks 404, 406) can be used in creating a command to create torque in the motor (block 408). In various embodiments, the motor is an AC induction motor. In some embodiments, the torque may be produced in the induction motor by applying a torque-producing current in quadrature to the weighted flux estimate.

If it is determined that the motor is within the transition range (block 402), then a weighted flux estimate may be used to generate a flux value (block 410). The weighted flux estimate is determined by using estimated flux from the voltage-based algorithm (block 404) and the estimated flux from the current-based algorithm (block 406). According to some embodiments, the weighted flux estimate will be variable over the transition range. The weighted flux estimate may use a heavier weighting for the flux estimate using current-based algorithm near the beginning of the transition range, and a heavier weighting for the flux estimate using voltage-based algorithm near the end of the transition range. The weighting may by proportional to the progress through the transition range in a linear fashion or through another functional proportionality.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

What is claimed is:

1. An apparatus for controlling an induction motor comprising:
a low speed module using a first algorithm to estimate flux;
a high speed module using a second algorithm to estimate flux; and
a weighting module to transition over a transition range from using the low speed module to using the high speed module by providing a flux estimate based on a weighted combination of a flux estimate from the first algorithm and a flux estimate from the second algorithm.

2. The apparatus of claim 1, further comprising a speed measurement module to measure rotor speed of the induction motor.

3. The apparatus of claim 2, wherein the transition range is determined based on rotations per minute (RPM) of the rotor of the induction motor.

4. The apparatus of claim 2, wherein the first algorithm estimates flux using current and rotor speed, and the second algorithm estimates flux using voltage and current.

5. The apparatus of claim 3, wherein the weighted combination of the flux estimate from the first algorithm and the flux estimate from the second algorithm is a weighted vector.

6. The apparatus of claim 1, wherein the transition range is based on at least one of stability and accuracy thresholds.

7. A method for controlling torque output of an induction motor comprising:
using a first algorithm to determine a first estimated flux value;
using a second algorithm to determine a second estimated flux value;
calculating a weighted flux estimate based on a combination of the first estimated flux value and the second estimated flux value; and
generating a voltage command using the weighted flux estimate to produce a torque output in the induction motor.

8. The method of claim 7, wherein the torque output is substantially proportional to the product of a torque producing current and the weighted flux estimate.

9. The method of claim 7, wherein the weighted flux estimate is based substantially on the first estimated flux value at low motor speeds.

10. The method of claim 7, wherein the weighted flux estimate is based substantially on the second estimated flux value at high motor speeds.

11. The method of claim 7, wherein the weighted flux estimate is based on a variably weighted combination of the estimated flux using the current-based algorithm and the estimated flux using the voltage-based algorithm during a motor speed transition range between low motor speeds and high motor speeds.

12. The method of claim 11, wherein the variably weighted combination of the estimated flux using the current-based algorithm and the estimated flux using the voltage-based algorithm is based on a linear weighting function during the motor speed transition range between low motor speeds and high motor speeds.

13. A vehicle including an electric drive comprising:
an electrically powered motor;
a controller to control the motor in response to a torque command;
a first module within the controller to determine a low motor speed flux estimate;
a second module within the controller to determine a high motor speed flux estimate; and
a third module within the controller to use the low motor speed flux estimate and the high motor speed flux estimate to estimate flux through the motor for motor speeds in a transition range between low motor speeds and high motor speeds.

14. The vehicle of claim 13, further comprising a speed module to determine motor speeds.

15. The vehicle of claim 13, wherein the third module uses a weighted sum of the low motor speed flux estimate and the high motor speed flux estimate to estimate flux through the motor.

16. The vehicle of claim 15, wherein the weighted sum is based on a linear weighting.

17. The vehicle of claim 13, wherein the transition range includes substantially all speeds.

18. The vehicle of claim 13, wherein the first module uses a current-based algorithm.

19. The vehicle of claim 13, wherein the second module uses a voltage-based algorithm.

20. The vehicle of claim 13, further comprising control modules within the controller in communication with the third module to send commands to the electrically powered motor based on the estimated flux through the motor during a transition range between low motor speeds and high motor speeds.
